(19) United States
(12) Patent Application Publication
(10) Pub. No.: US 2019/0286302 A1
(43) Pub. Date: Sep. 19, 2019

(54) INTERACTIVE AND ADAPTABLE FOCUS MAGNIFICATION SYSTEM

(71) Applicant: Microsoft Technology Licensing, LLC, Redmond, WA (US)

(72) Inventors: Paul J. Reid, Woodinville, WA (US); Jason A. Grieves, Bellevue, WA (US)

(21) Appl. No.: 15/921,493

(22) Filed: Mar. 14, 2018

(51) Int. Cl. G06F 3/0484; G06F 3/0482

(52) U.S. Cl. CPC G06F 3/04845; G06F 2203/04805; G06F 3/0482

(57) ABSTRACT

Methods, systems, and apparatuses in a computing device enable magnification of selectable display objects. A first interaction event associated with a first selectable display object displayed in a display screen, the display screen having a boundary and a current magnification level is detected. A first display location and a first unmagnified size of the first selectable display object in the display screen is determined and a magnified display size for the first selectable display object based at least on the first unmagnified size is determined. A second display location for the first selectable display object based at least on the first display location is determined and the first selectable display object is displayed at the magnified display size and at the second display location on the display screen. The display screen is otherwise displayed entirely at the current magnification level.

### BACKGROUND

Screen magnifier applications enlarge different parts of a display screen based on the specified magnifier mode. Conventional systems offer three basic magnification modes: full-screen mode, lens mode, and docked mode. In full-screen mode, the entire physical screen shows a magnified portion of the desktop and its applications while the mouse pointer is moved. In lens mode, a defined and static area around the mouse pointer is magnified while a user moves the pointer around the display screen, which may leave a screen item having a magnified portion within the area while the rest of the screen item outside the area is unmagnified. In docked mode, only a defined and static portion of the screen is magnified, leaving the rest of the display screen unchanged.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for enabling the magnification of selectable display objects in a display screen, in particular enabling the magnification of a selectable display object in its entirety while leaving the display screen otherwise unaffected. For instance, a display magnification system may include a magnification event monitor, a magnified object size determiner, a magnified object location determiner, and a display interface. The magnification event monitor is configured to detect a first interaction event associated with a first selectable display object displayed in a display screen, and to determine a first display location and a first unmagnified size of the first selectable display object in the display screen. The magnified object size determiner is configured to determine a magnified display size for the first selectable display object based at least on the first unmagnified size. The magnified object location determiner is configured to determine a second display location for the first selectable display object based at least on the first display location. The display interface is configured to display the first selectable display object at the magnified display size and at the second display location on the display screen.

Further features and advantages of the invention, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for enabling the magnification of selectable display objects, according to an example embodiment.

FIG. 2 shows a flowchart for enabling the magnification of a selectable display object, according to an example embodiment.

FIG. 3 shows a block diagram of a display magnification system for enabling the magnification of selectable display objects, according to an example embodiment.

FIG. 4A shows a block diagram of a display screen comprising an array of pixels illustrating the magnification of a selectable display object, according to an example embodiment.

FIGS. 4B-4E show block diagrams of the display screen of FIG. 1, illustrating the magnification of selectable display objects, according to example embodiments.

FIG. 5 shows a flowchart for initiating a focus magnification mode, according to an example embodiment.

FIG. 6 shows a flowchart for determining a magnified display size for a selectable display object, according to an example embodiment.

FIG. 7 shows a flowchart for determining a second display location for a selectable display object based at least on a first display location for the selectable display object, according to an example embodiment.

FIG. 8 shows a flowchart for enabling the magnification of a second selectable display object, according to an example embodiment.

FIG. 9 shows a flowchart for enabling user interaction events to sequence the magnification of selectable display objects, according to an example embodiment.

FIG. 10 is a block diagram of an example processor-based computer system that may be used to implement various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

As noted above, screen magnifier apps enlarge different parts of a display screen based on a specified magnifier mode (e.g., full-screen mode, lens mode, or docked mode.) However, such screen-based magnification modes have limitations. For instance, in the full-screen mode, depending on the size of the display screen and the chosen magnification level, a user may not be able to view the entire display screen at the same time. Even at a 2× magnification level, the user can only view one-fourth of the display screen at a time. In order to view the other three-fourths of the display screen, the user has to scroll around the display screen with, for example a mouse, touch, or other input device. The lens mode requires the user to use the mouse pointer or touch to move around the screen to magnify screen regions. In many cases, an object of interest for magnification does not fit entirely in the area of the lens, forcing the user to move the lens around to view portions of the object magnified. The docked mode also magnifies just a screen portion that is static. Still further, the areas of the lens in the lens mode and the magnified areas of the docked mode have to be set manually and remain static until updated by a user. Accordingly, a user desiring to magnify an entire object anywhere in the display screen is compromised by these existing magnifier modes.

Embodiments overcome these and other issues related to screen magnification and/or screen magnification applications (apps). In embodiments, a user is enabled to initiate a focus magnification mode that interactively and adaptively (e.g., automatically) magnifies selectable display objects on a display screen. In other words, the magnification area is adapted to be that of the particular selectable display object selected for magnification, such that the entire selected selectable display object is magnified within the display screen without magnifying other portions of the display screen. If an object, when magnified, would be displayed partially off-screen, the magnification display location may be automatically and intelligently adjusted such that the magnified selectable display object is fully displayed within the display screen (this assumes the magnified selectable display object can fit entirely in the display screen). Embodiments further enable a user to easily step through and individually magnify displayed selectable display objects, thus providing for an improved user experience. Still further, a user can view a magnified selectable display object along with other unmagnified selectable display objects in the display screen, and thus can identify further selectable display objects to select for magnification if desired.

In an embodiment, a computing device is configured to enable the magnification of selectable display objects. The computing device may be any computing machine such as but not limited to a desktop or laptop computer, a mobile device, a gaming system (e.g., Microsoft Xbox), terminal based PC's (e.g., automatic teller machines (ATM)), or the like. In embodiments, the computing device includes a display screen (which may be formed of a single physical display screen, or multiple physically separate display screens) in which one or more selectable display objects are displayed. A selectable display object as referred to herein is any selectable object displayed in a display screen, including a user interface (UI) control, an instance of displayed content, and any other type of displayed object that is selectable. Examples of selectable display objects include a GUI button, a text box, a pull-down menu selector, a check box, a scroll bar, an icon (e.g., a folder icon, a desktop application icon), and a GUI window. Automatically selectable display objects include those selectable display objects tracked/identifiable by a display manager of an operating system, such desktop icons, window start menu icons (e.g., for executable applications), application windows, computer settings controls, etc. Manually selectable display objects include those that are manually selectable within the computer desktop, as well as those present within an application open in the display screen, such as a cell, row, or column in a spreadsheet application, text and/or images in an application, etc. In embodiments, the display screen has a boundary and a current magnification level (e.g., 100% or other value; default or user modified) such that the unselected selectable display objects are displayed in the display screen within the boundary and at the current magnification level.

For example, a desktop screen generated and displayed by an operating system of a computing device may display a background, upon which is displayed numerous selectable display objects, such as several icons corresponding to applications, folders, and files, an open rectangular window providing configurable computer settings, an open spreadsheet application, and several icons displayed in a task bar. Embodiments described herein may enable independent magnification of each of these selectable display objects. Furthermore, when a selectable display object is magnified, the object is magnified in its entirety, not partially, as may occur in a lens magnifier or docked magnifier. Furthermore, the magnified object is shown on the screen in its entirety (assuming the magnified object fits in the full screen at the particular magnification level), not missing from or partially shown on the screen as may occur during full screen magnification. For instance, each of the above-mentioned example desktop display may be independently magnified, including each desktop icon, the open settings window, each UI control in the settings window, the spreadsheet application, and each icon in the task bar. In an embodiment, the independent magnification of each selectable display object may be sequenced through, such as by user interaction with a UI element (e.g., a tab key, a mouse click, etc.). Each UI interaction event (e.g., tab key pressing) cause a next selectable display object to be selected and magnified.

Any shape of selectable display object may be magnified in its entirety, including round, oval, polygonal such square, rectangular, or triangular, as well as irregular shapes, etc. For instance, a one-inch by one-inch icon may be magnified in its entirety. In another example, a UI control that is a check box with accompanying text (e.g., “Enable bitmap smoothing”), which has relatively small height but long length, may be magnified in its entirety (check box and text magnified together). In still another example, a UI control that is a toggle switch with accompanying text (e.g., “Start Narrator automatically” positioned above the toggle switch, and an “Off” indication to the right of the toggle switch), of may be magnified in its entirety (toggle switch and text magnified together).

Note that in an embodiment, selectable display objects may be identified for the magnifier (e.g., for sequential magnification) automatically, such as by the display manager (e.g., window manager) for an operating system, which may track objects displayed in the desktop, as well as manual identification of objects by a user. For instance, a user may select a desktop object for magnification, such as those described above, as well as being enabled to select selectable display objects within an application, such as cells, columns, rows, etc., within a spreadsheet application, words, paragraphs, or other blocks of text and/or images in a word processing application, etc.

In an embodiment, the computing device includes a display magnification system that is configured to interface directly with the display screen and with a user via a user interface. For instance, a user may interact with the display magnification system via a focus magnification mode control of the user interface to enter the focus magnification mode, thereby enabling the magnification of selectable display objects. Furthermore, the display magnification system may interface with a display screen to magnify and un-magnify the selectable display objects displayed in the display screen.

In an embodiment, the display magnification system includes a magnifier mode initiator that is configured to initiate a focus magnification mode for display of selected selectable display objects in the display screen. For instance, in response to user interaction, the focus magnification mode control is configured to the alert magnifier mode initiator to enter into the focus magnification mode. Once the focus magnification mode is initiated, then the selectable display objects are monitored for an interaction event. The interaction event is any interaction that indicates that a selectable display object should be magnified. For instance, an interaction event may include a tabbing, an arrowing, a hover, a pointer selection (e.g., selection of text, a selection of a word, line, paragraph, etc.), a touch, a cursor, or the like. Furthermore, the interaction event may be the result of an input from any input to the computing device such as, a keyboard, a mouse, a controller (i.e., Xbox controller), a TV remote, a touchscreen, one or more physical buttons (i.e., an ATM), or the like. In an embodiment, the magnification event monitor is configured to enable user interaction events to step through selectable display objects for individual magnified display in the display screen.

In an embodiment, to monitor for an interaction event, the display magnification system includes a magnification event monitor that is configured to detect an interaction event associated with a selectable display object displayed in a display screen. To ensure the accurate monitoring of selectable display objects, the magnification event monitor implements an event accessor on the objects and focus to detect interaction events. The magnification event monitor may be included in any UI framework capable of implementing accessibility APIs on controls and focus to detect interaction events. The event accessor may be, for example, an application programming interface that allows one to access, identify, and manipulate selectable display objects of another application.

In an embodiment, once an interaction event is detected for a selectable display object to be magnified, the magnification event monitor is further configured to determine a display location, an unmagnified size, and/or other attributes of the selectable display object in the display screen. In this way, the magnification event monitor can provide an indication of the interaction event and the attributes to other components of the display magnification system such that a magnified size and location can be determined for the selectable display object.

In an embodiment, the display magnification system further includes a magnified object size determiner that is configured to determine a magnified display size for selectable display objects based on their corresponding unmagnified display size. For instance, the magnified object size determiner may determine the magnified selectable display object display size based on the magnification level associated with the focus magnification mode. The magnification level associated with the focus magnification mode may be defined/selected by the user or may be a default value of the focus magnification mode. Furthermore, the magnification level may be dynamic.

In an embodiment, the display magnification system further includes a magnified object location determiner configured to determine a magnified display location for selectable display objects to be magnified based at least on the unmagnified display location of the corresponding selectable display objects. For instance, the magnified display location may be determined relative to the unmagnified display location for the selectable display object. In an embodiment, the magnified object location determiner may determine the magnified display location to be centered on the first display location. In another embodiment, the magnified object location determiner may determine the magnified display location as being shifted the left, the right, upwards, or downwards of the first display location, or may be a combination thereof (e.g., shifted left and upwards by predetermined distances).

In an embodiment, and as noted above, if the magnified display location of the selectable display object results in the selectable display object displayed at the magnified display size being displayed outside of the boundary of the display screen, the display magnification system may adjust the magnified display location of the selectable display object. The magnified object location determiner may generate an updated magnified display location as an adjustment of the default magnified display location to enable the selectable display object, at the magnified display size, to fit within the boundary. This updated magnified display location becomes the magnified display location.

The display magnification system may further include a display interface configured to interface with the display screen to display the magnified selectable display object at a determined magnified display size and a determined magnified display location. Thus, fater the magnified display size and magnified display location of a selectable display object is determined, the display interface may transmit the selectable display object and magnified attributes (i.e., magnified display size and magnified display location) to be displayed in the display screen. Other objects in the display screen are displayed entirely at the magnification level currently set for the display screen, rather than at the magnification level of the magnified selectable display object.

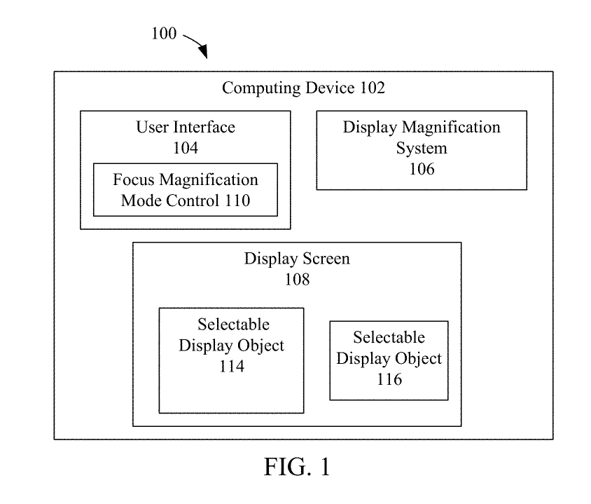

Such embodiments may be implemented in various ways. For instance, FIG. 1 shows a system 100 for enabling the magnification of selectable display objects, according to an embodiment. As shown in FIG. 1, system 100 includes a computing device 102 which includes a user interface 104, a display magnification system 106, and a display screen 108. User interface 104 includes a focus magnification mode control 110. Display screen 108 includes first selectable display object 114 and second selectable display object 116. It is noted that although a single display screen is shown in computing device 102, the shown display screen may be composed of one or more physical display screens. Furthermore, although two selectable display objects are shown in display screen 108, any number of selectable display objects may be present. These and further features of FIG. 1 are described as follows.

Computing device 102 may be any type of stationary or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a Blackberry® device, etc.), a stationary computing device such as a desktop computer or PC (personal computer), a gaming system (Xbox®), terminal based PC's (ATM's), or the like.

As shown in FIG. 1, computing device 102 includes display screen 108. Display screen 108 is the display surface of computing device 102 capable of displaying graphical information to users, such as through the use of an array of display pixels. For instance, display screen 108 displays selectable display object 114 and selectable display object 116, optionally within one or more GUI windows. Display screen 108 has a boundary within which information can be displayed (e.g., a region of pixels), but outside of which, information cannot be displayed (no pixels present). In embodiments, and as discussed hereinafter, selectable display object 114 and selectable display object 116 are enabled to be magnified when focus magnification mode is initiated or entered. For instance, as shown in the configuration of FIG. 1, selectable display object 114 is shown is magnified form (displayed at magnification different from a current magnification level of display screen 108) and selectable display object 116 is shown in un-magnified or default form (displayed according to a current magnification level of display screen 108).

User interface 104 of computing device 102 enables users of computing device 102 to interact therewith. User interface 104 may be any type of interface capable of enabling a user to interface with computing device 102 such as a graphical user interface (GUI), a voice user interface, a touch user interface, a text-based user interface, a touchscreen user interface, a motion tracking interface, a gesture interface, or the like. In an embodiment, user interface 104 may enable a user to initiate a focus magnification mode for magnification of selectable display objects. For instance, and as shown in FIG. 1, user interface 104 includes focus magnification mode control 110. In an embodiment, user interface 104 may be GUI displayed in display screen 108. Display magnification system 106 of computing device 102 is configured be initiated by focus magnification mode control 110 to initiate the focus magnification mode disclosed herein.

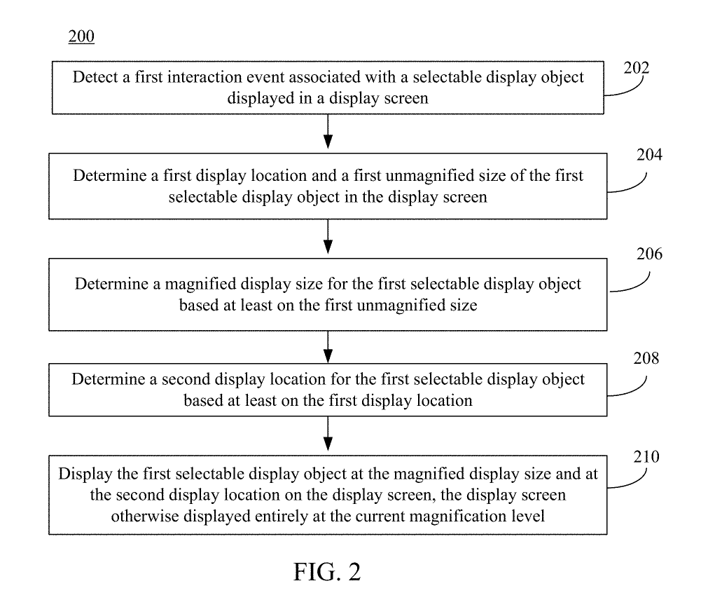

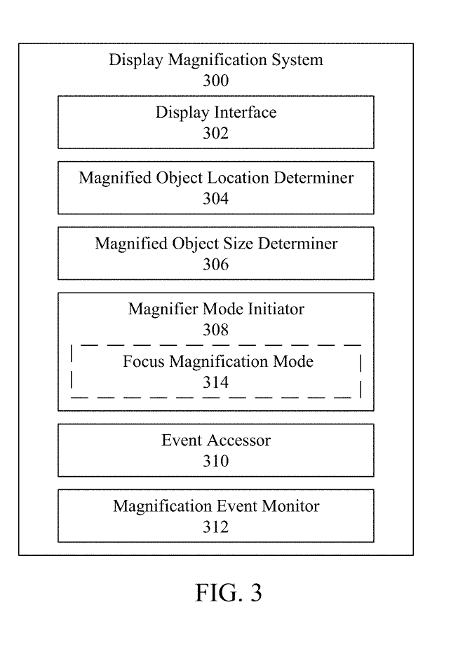

In embodiments, display magnification system 106 may operate in various ways to enable magnification of selectable display objects. For example, FIG. 2 shows a flowchart 200 for enabling the magnification of a selectable display object, according to an example embodiment. In an embodiment, flowchart 200 may be implemented by display magnification system 106. For the purposes of illustration, flowchart 200 of FIG. 2 is described with continued reference to FIG. 1 and with respect to FIG. 3. FIG. 3 shows a block diagram of a display magnification system 300 for enabling the magnification of selectable display objects, according to an example embodiment. Displays magnification system 300 is an example of display magnification system 106 of FIG. 1. As shown in FIG. 3, display magnification system 106 includes a display interface 302, a magnified object location determiner 304, a magnified object size determiner 306, a magnifier mode initiator 308, an event accessor 310, and a magnification event monitor 312. In an embodiment, magnified object size determiner 306 and magnified object location determiner 304 are part of magnifier mode initiator 308. Alternatively, magnified object size determiner 306 and magnified object location determiner 304 may be independent of magnifier mode initiator 306.

Note that the steps of flowchart 200 may be performed in an order different than shown in FIG. 2 in some embodiments. Furthermore, not all steps of flowchart 200 need to be performed in all embodiments. Other structural and operational embodiments will be apparent to persons skilled in the relevant art(s) based on the following discussion regarding flowchart 200, system 100 of FIG. 1, display magnification system 300 and FIG. 3.

Flowchart 200 begins with step 202. In step 202, a first interaction event associated with a first selectable display object is detected. For instance, with reference to FIG. 3, magnification event monitor 312 may be configured to detect a first interaction event associated with a first selectable display object. As noted above, the interaction event may be any event that causes selection of the selectable display object such as a tabbing, an arrowing, a hover, a selection (e.g., selection of text, a selection of a word, line, paragraph, etc.), a touch, a cursor, or the like. In one illustrative example, magnification event monitor 312 may detect that a user selects a folder labeled “Family Photographs” using a mouse pointer.

As noted above, magnification event monitor 312 may be configured to be prompted to monitor for the occurrence of an interaction event in step 202 after the focus magnification mode is entered. For instance, and as shown in FIG. 3 and with continued reference to FIG. 1, magnifier mode initiator 308 is configured to receive an input from a user of user interface 104 to initiate focus magnification mode 314.

Magnification event monitor 312 may be configured in various ways to perform its functions. In an embodiment, magnification event monitor 312 may be configured in a UI framework capable of implementing accessibility APIs on control and/or focus to detect interaction events. Event accessor 310 is optionally present. In an embodiment, when an interaction event is detected by magnification event monitor 312, event accessor 310 is alerted, which provides the interaction event to one or more of the other components of display magnification system 300, discussed in detail hereinafter. Alternatively, magnification event monitor 312 directly to one or more of the other components of display magnification system 300.

Referring back to FIG. 2, in step 204, a first display location and a first unmagnified size of the first selectable display object in the display screen is determined. For instance, with reference to FIG. 3, magnification event monitor 312 is configured to determine a first display location and a first unmagnified size of the first selectable display object in the display screen. In an embodiment, an operating system window/screen manager may track locations and sizes of selectable display objects. A location of a selectable display object may be indicated in any manner, such as in the form of x-y coordinates (e.g., pixel coordinates) of a corner position of the selectable display object, or in any other manner. The size of a selectable display object may be indicated in any manner, including a set of coordinates of corners of the selectable display object (when rectangular), measured or calculated width and height of the object, and/or in any other manner.

For example, magnification event monitor 312 may determine that the folder “Family Photographs” has an unmagnified display size indicated by a set of corner coordinates (10, 10), (20, 10), (10, 30), (20, 30), which can be converted to a 11 by 21 width and height (in pixels), and an unmagnified display location (upper left corner) of (10, 10).

In step 206, a magnified display size for the first selectable display object is determined based at least on the first unmagnified size. For instance, with reference to FIG. 3, magnified object size determiner 306, in the focus magnification mode, is configured to determine a magnified display size for the first selectable display object based at least on the first unmagnified size. In an embodiment, magnified object size determiner 306 is prompted to determine the magnified display size for a selectable display object by being provided an interaction event by subscribing to event accessor 310.

For example, magnified object size determiner 306 may determine a magnified display size for the “Family Photographs” folder based on the magnification level of the focus magnification mode. For a 2× magnification level, and for the above-identified example size of the folder of 11 by 21, magnified object size determiner 306 multiplies the size of 11 by 21 by the magnification factor of 2 to determine a magnified display size for the folder of 22 by 42.

In step 208, a second display location for the first selectable display object based at least on the first display location is determined. For instance, with reference to FIG. 3, magnified object location determiner 304, in the focus magnification mode, is configured to determine a second display location for the first selectable display object based at least on the first display location. For instance, magnified object location determiner 304 may determine an updated display location based on the initial unmagnified display location. In an embodiment, magnified object location determiner 308 is prompted to determine the magnified display size for a selectable display object by being provided an interaction event by subscribing to event accessor 310.

For example, magnified object location determiner 304 may determine a second display location for the “Family Photographs” folder based on the first display location for the folder. For example, magnified object location determiner 304 may be configured to determine the second display location to be relative to the first display location, such as being shifted left and up by 5 pixels each. In such case, magnified object location determiner 304 may subtract 5 from each of the (10, 10) coordinates of the first location to determine the second location to have the coordinates of (5, 5). However, as noted above, the initial unmagnified display location may fit within the display screen such that the magnified displayed location does not need to be updated.

In step 210, the first selectable display object is displayed at the magnified display size and at the second display location on the display screen, the display screen otherwise displayed entirely at the current magnification level. For instance, with reference to FIG. 1 and FIG. 3, display interface 302 is configured to display the first selectable display object at the magnified display size and at the second display location on display screen 108. As noted above, the display screen is otherwise displayed entirely at the current magnification level.

For example, display interface 302 may display the “Family Photographs” folder within display screen 108 at the determined magnified display size and updated display location. The upper left corner of the folder may be displayed on display screen 108 at coordinates (5, 5), and the folder may be displayed in display screen 108 at the magnified size of 22 by 42, with each pixel of the unmagnified folder displayed at twice the size (a 2×2 pixel) in the magnified version of the folder. However, as noted above, the initial unmagnified display location may fit within the display screen such that the magnified displayed location does not need to be updated.

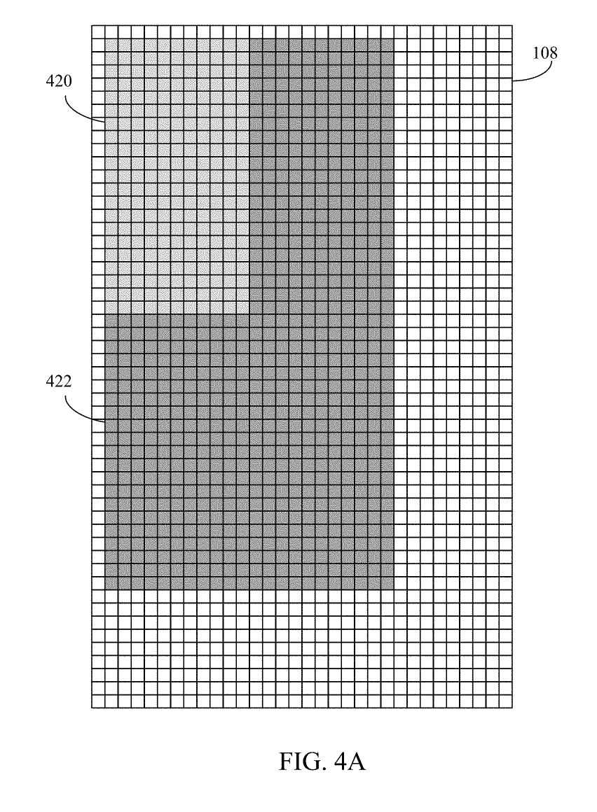

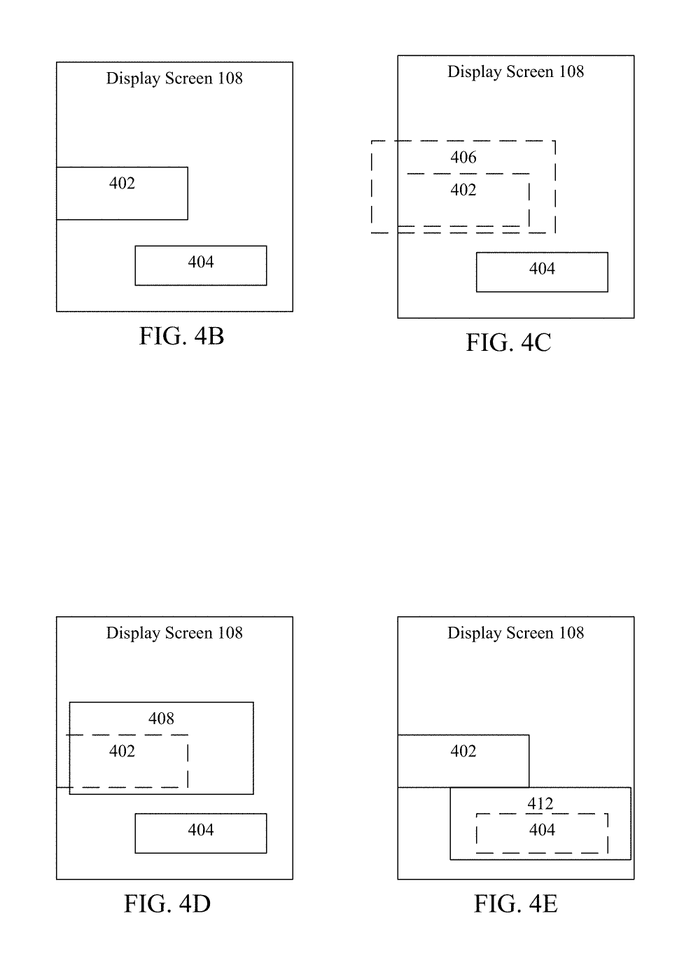

FIG. 4A illustrates this magnification of the example “Family Photographs” folder. In particular, FIG. 4A shows a block diagram of display screen 108 displaying an unmagnified selectable display object 420 and a magnified selectable display object 422, overlain on each other. Unmagnified selectable display object 420 has the unmagnified display size on display screen 108 of 11 pixels across and 21 pixels down and an unmagnified display location of (10, 10) (i.e., the upper left corner). Furthermore, magnified selectable display object 422 has the magnified display size on display screen 108 of 22 pixels across and 42 pixels down (magnified selectable display object 422 includes the area of unmagnified selectable display object 420). Accordingly, magnified selectable display object 422 is a 2× magnification level version of unmagnified selectable display object 420. Furthermore, magnified first selectable display object 422 has the same display location as the unmagnified display location (10, 10) (same upper left corner).

Accordingly, selectable display objects are enabled to be displayed in a magnified manner in a display screen without magnifying the rest of the display screen. Only the selectable display object is displayed magnified, and is displayed magnified in its entirety. This provides clear benefits over prior approaches, such as lens magnifiers, which may only magnify a portion of a selectable display object (the portion within the lens area), while the rest of the selectable display object is displayed at the same magnification level as the rest of the display screen.

A graphical example of such magnification is illustrated with respect to FIGS. 4B-4E, as described as follows. FIGS. 4B-4E show block diagrams of the display screen of FIG. 1 illustrating the magnification of selectable display objects, according to example embodiments. FIGS. 4B-4E are described as follows.

FIG. 4B shows display screen 108 displaying a first selectable display object 402 and a second selectable display object 404, both in unmagnified form. In the example of FIG. 4B, display screen 108 has a boundary indicated by the rectangular box of display screen 108. As noted above, and with continued reference to FIGS. 1 and 3, if display magnification system 106 has entered focus magnification mode 314, selectable display objects in display screen 108 are enabled to be magnified in response to an event indication detection.

FIG. 4C shows display screen 108 where an event indication associated with selectable display object 402 was received by magnification event monitor 312 (step 202 of FIG. 2). As described above, in step 204 of flowchart 200, a first display location and unmagnified display size of selectable display object 402 are determined. In step 206, a magnified display size of selectable display object 402 is determined based on the unmagnified display size by magnified object size determiner 306. For instance, FIG. 4C shows an outline of a magnified selectable display object 406 having the magnified display size of selectable display object 402. In step 208, a second display location is determined based on the first display location of selectable display object 402 by magnified object location determiner 304. As shown in FIG. 4C, the magnified display size of magnified selectable display object 406 does not fit within the boundary of display screen 108 when displayed at the second display location. As such, magnified object location determiner 304 is configured to adjust the magnified display location of selectable display object 402.

For example, as shown in FIG. 4D, magnified object location determiner 304 may adjust the second display location (e.g., shifting the display location to the right) to generate an adjusted second display location for a magnified version of selectable display object 402. For instance, a location-shifted magnified selectable display object 408 is an adjusted magnified version of selectable display object 402 that fits within the boundary of display screen 108 when displayed. Note that selectable display object 404 is displayed in an unmagnified form in FIGS. 4B-4D because no indication event is yet received for selectable display object 404.

Referring to FIG. 4E, an event indication has been received associated with selectable display object 404 of FIG. 4B. As such, display screen 108 of FIG. 4E displays the selectable display object 402 (unmagnified as in FIG. 4B) and a magnified selectable display object 412 determined as magnified version of selectable display object 404 in a manner as described above. Note magnified selectable display object 412 fit within the boundary of display screen 108 without adjustment. Furthermore, note that the event indication detected for selectable display object 402, caused display magnification system 106 to return magnified selectable display object 408 to its previous unmagnified version, selectable display object 402.

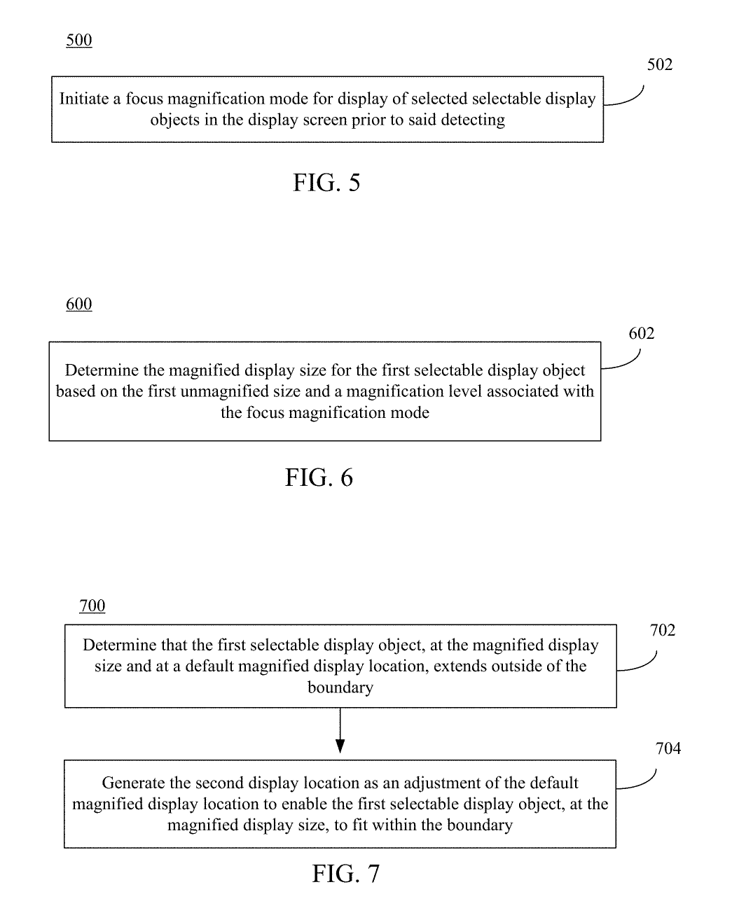

Note that the above-described embodiments may be modified in various ways. For instance, FIGS. 5-9 show flowcharts providing further details and modifications that may be may be made to embodiments. FIGS. 5-9 are described as follows.

FIG. 5 shows a flowchart 500 for initiating a focus magnification mode, according to an example embodiment. Flowchart 500 may be performed as an initial step to flowchart 200 (FIG. 2), and may be implemented by magnifier mode initiator 308 of FIG. 3, in an embodiment. Flowchart 500 is described as follows. Other structural and operational embodiments will be apparent to persons skilled in the relevant art(s) based on the following discussion regarding flowchart 500.

Flowchart 500 begins with step 502. In step 502, a focus magnification mode is initiated for display of selected selectable display objects in the display screen prior to detecting an event. For instance, with continued reference to FIG. 1 and FIG. 3, a user may initiate focus magnification mode via magnification mode control 110. In such case, user interface 104 may provide initiation signal to magnifier mode initiator 308 to initiate the focus magnification mode.

FIG. 6 shows a flowchart 600 for determining a magnified display size for the first selectable display object, according to an example embodiment. Flowchart 600 may be performed, for example, as part of step 206 according to flowchart 200 as described above. Flowchart 600 may be implemented by magnified object size determiner 306 of FIG. 3, in embodiments. Flowchart 600 is described as follows. Other structural and operational embodiments will be apparent to persons skilled in the relevant art(s) based on the following discussion regarding flowchart 600.

Flowchart 600 begins with step 602. In step 602, the magnified display size for the first selectable display object is determined based on the first unmagnified size and a magnification level associated with the focus magnification mode. For instance, and with reference to FIG. 3, magnified object size determiner 306 determines the magnified display size for a selectable display object and a magnification level associated with the focus magnification mode 314. For example, as described above, magnified object size determiner 306 may determine the unmagnified display size based on a coordinates and/or dimensions maintained by an operating system, a windows system, etc., and may determine the magnification level associated with the magnification mode (e.g., as a stored attribute of the focus magnification mode). Magnified object size determiner 306 is configured to apply the magnification level to the unmagnified size (e.g., by multiplication or division) to determine the magnified size of the selectable display object.

FIG. 7 shows a flowchart 700 for determining a second (magnified) display location for the first selectable display object based at least on the first (unmagnified) display location, according to an example embodiment. Flowchart 700 may be performed, for example, as part of performing step 208 according to flowchart 200 as described above. Flowchart 700 may be implemented by magnified object location determiner 304 of FIG. 3, in embodiments. Flowchart 700 is described as follows. Other structural and operational embodiments will be apparent to persons skilled in the relevant art(s) based on the following discussion regarding flowchart 700.

Flowchart 700 begins with step 702. In step 702, it is determined that the first selectable display object extends outside of the boundary at the magnified display size and at a default magnified display location. For instance, with reference to FIG. 3 and FIG. 4C, magnified object location determiner 308 determines that at the magnified display size and default magnified display location, selectable display object 402, displayed in magnified form as magnified selectable display object 406, extends outside of the boundary of display screen 108.

At step 704, the second display location is generated as an adjustment of the default magnified display location to enable the first selectable display object to fit within the boundary at the magnified display size. For instance, as described above with reference to FIG. 4D, magnified object location determiner 308 generates a second display location for selectable display object 402 (as shown for magnified selectable display object 408) that enables the magnified form of selectable display object 402 to be displayed within the boundary of display screen 108.

Note that a user may be enabled to sequence through displayed selectable display objects when in the focus magnification mode, such that each selectable display object is independently selected and displayed in magnified form. Each time a selectable display object is selected, an interaction event is generated that causes the selectable display object to be displayed in magnified form.

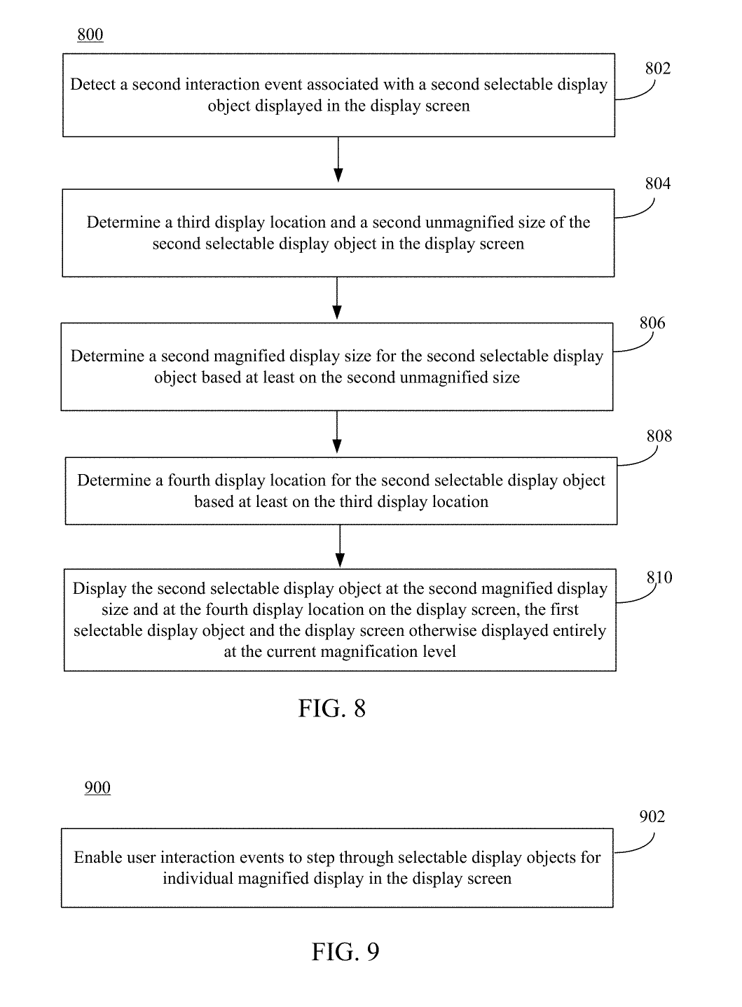

For instance, FIG. 8 shows a flowchart 800 for enabling the magnification of a second selectable display object, according to an example embodiment. Flowchart 800 may be implemented by display magnification system 106 of FIG. 1, in embodiments. Flowchart 800 is described as follows. Other structural and operational embodiments will be apparent to persons skilled in the relevant art(s) based on the following discussion regarding flowchart 800.

Flowchart 800 begins with step 802. In step 802, a second interaction event associated with a second selectable display object displayed in the display screen is detected. For instance, and with reference to FIG. 3 and FIG. 4E, subsequent to displaying selectable display object 402 (the “Family Photographs” folder) in magnified form, magnification event monitor 312 may detect a second interaction event associated with selectable display object 404 in the display area of display screen 108. For example, magnification event monitor 312 may detect that a user selects by tabbing, mouse pointer, keyboard, touchscreen, etc. (second interaction event) a second folder “Tax Returns” (selectable display object 404).

At step 804, a third display location and a second unmagnified size of the second selectable display object in the display screen is determined. For instance, and with continued reference to FIG. 3 and FIG. 4E, magnification event monitor 312 determines an unmagnified display location and an unmagnified display size of selectable display object 404 (e.g., the “Tax Returns” folder).

At step 806, a second magnified display size for the second selectable display object is determined based at least on the second unmagnified size. For instance, and with continued reference to FIG. 3 and FIG. 4E, magnified object size determiner 306 may determine a magnified display size for selectable display object 404 based on the unmagnified display size of selectable display object 404 (e.g., the “Tax Returns” folder).

At step 808, a fourth display location for the second selectable display object is determined based at least on the third display location. For instance, and with continued reference to FIG. 3 and FIG. 4E, magnified object location determiner 304 determines a magnified display location for selectable display object 404 (e.g., the “Tax Returns” folder) based at least on the unmagnified display location.

At step 810, the second selectable display object is displayed at the second magnified display size and at the fourth display location on the display screen, the first selectable display object and the display screen otherwise displayed entirely at the current magnification level. For instance, and with continued reference to FIG. 3 and FIG. 4E, display interface 302 interfaces with display screen 108 to cause selectable display object 404 (e.g., the “Tax Returns” folder) to be displayed in magnified form (e.g., a magnification factor of 200%) as magnified selectable display object 404. Note that display screen 108 is otherwise displayed at the current magnification level (e.g., 100%) for display screen 108, including selectable display object 402.

FIG. 9 shows a flowchart 900 for enabling user interaction events to step through magnification of selectable display objects. Flowchart 900 may be implemented by magnification event monitor 312 of FIG. 3, in embodiments. Flowchart 900 is described as follows. Other structural and operational embodiments will be apparent to persons skilled in the relevant art(s) based on the following discussion regarding flowchart 900.

Flowchart 900 begins with step 902. In step 902, user interaction events are enabled to step through selectable display objects for individual magnified display in the display screen. For instance, magnification event monitor 312 enables user interaction events to step through selectable display objects for individual magnified display in display screen 108 by receiving events corresponding to user UI interaction to cause sequencing of magnified objects. An identification of available selectable display objects may be maintained by a display manager (e.g., windows manager) of the operating system, which may store an object identifier for each object, along with a location and size indication for corresponding to the object identifier. Magnification event monitor 312 may access the location and size for the object identifier corresponding to each object in the sequence, which may be processed by magnified object location determiner 304 and magnified object size determiner 306 to determine the magnified locations and sizes for the magnified objects for display.

For instance, as shown in FIG. 4D and described above, selectable display object 402 may be a first object in the sequence, displayed as magnified selectable display object 408, followed by selectable display object 404 being displayed as magnified selectable display object 412 in FIG. 4E (e.g., a user may step from magnification of the “Family Photographs” folder to magnification of the “Tax Returns” folder), and so on. Any number of selectable display objects may be stepped through for magnification in this manner.

### III. Example Computer System Implementation

Computing device 102, display magnification system 106, display interface 302, magnified object location determiner 304, magnified object size determiner 306, magnifier mode initiator 308, event accessor 310, magnification event monitor 312, flowchart 200, flowchart 500, flowchart 600, flowchart 700, flowchart 800, and flowchart 900, may be implemented in hardware, or hardware combined with one or both of software and/or firmware. For example, display magnification system 106, display interface 302, magnified object location determiner 304, magnified object size determiner 306, magnifier mode initiator 308, event accessor 310, magnification event monitor 312, flowchart 200, flowchart 500, flowchart 600, flowchart 700, flowchart 800, and flowchart 900 may be implemented as computer program code/instructions configured to be executed in one or more processors and stored in a computer readable storage medium. Alternatively, display magnification system 106, display interface 302, magnified object location determiner 304, magnified object size determiner 306, magnifier mode initiator 308, event accessor 310, magnification event monitor 312, flowchart 200, flowchart 500, flowchart 600, flowchart 700, flowchart 800, and flowchart 900 may be implemented as hardware logic/electrical circuitry.

For instance, in an embodiment, one or more, in any combination, of display magnification system 106, display interface 302, magnified object location determiner 304, magnified object size determiner 306, magnifier mode initiator 308, event accessor 310, magnification event monitor 312, flowchart 200, flowchart 500, flowchart 600, flowchart 700, flowchart 800, and flowchart 900 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

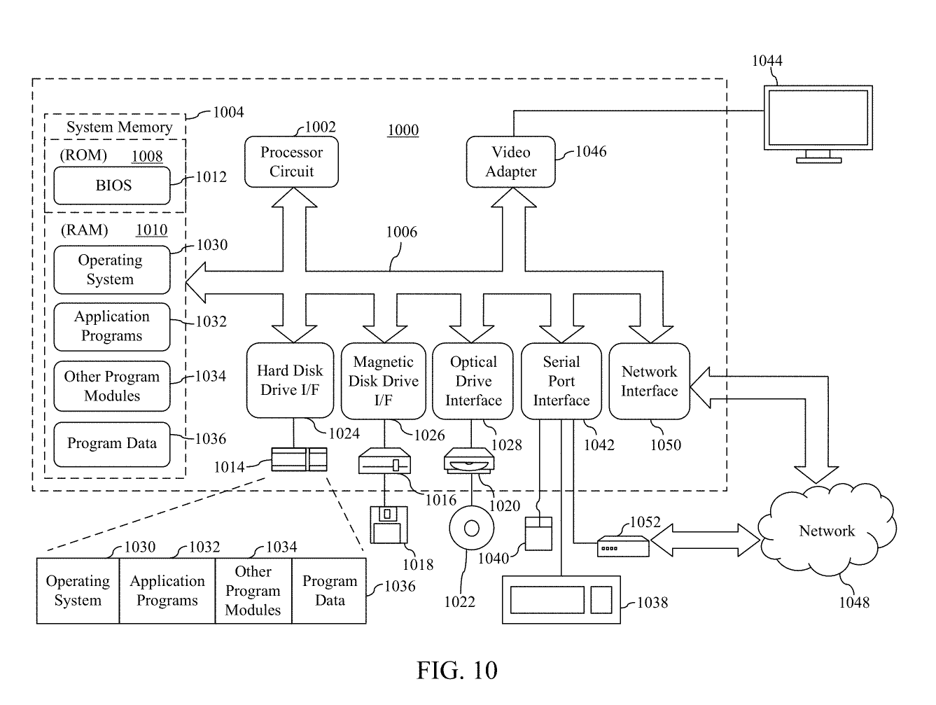

FIG. 10 depicts an exemplary implementation of a computing device 1000 in which embodiments may be implemented. For example, computing device 102 may each be implemented in one or more computing devices similar to computing device 1000 in stationary or mobile computer embodiments, including one or more features of computing device 1000 and/or alternative features. The description of computing device 1000 provided herein is provided for purposes of illustration, and is not intended to be limiting. Embodiments may be implemented in further types of computer systems, as would be known to persons skilled in the relevant art(s).

As shown in FIG. 10, computing device 1000 includes one or more processors, referred to as processor circuit 1002, a system memory 1004, and a bus 1006 that couples various system components including system memory 1004 to processor circuit 1002. Processor circuit 1002 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1002 may execute program code stored in a computer readable medium, such as program code of operating system 1030, application programs 1032, other programs 1034, etc. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computing device 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1030, one or more application programs 1032, other programs 1034, and program data 1036. Application programs 1032 or other programs 1034 may include, for example, computer program logic (e.g., computer program code or instructions) for implementing display magnification system 106, display interface 302, magnified object location determiner 304, magnified object size determiner 306, magnifier mode initiator 308, event accessor 310, magnification event monitor 312, flowchart 200, flowchart 500, flowchart 600, flowchart 700, flowchart 800, and flowchart 900, and/or further embodiments described herein.

A user may enter commands and information into the computing device 1000 through input devices such as keyboard 1038 and pointing device 1040. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1002 through a serial port interface 1042 that is coupled to bus 1006, but may be connected by other interfaces, such as a parallel port, game port, or a universal serial bus (USB).

A display screen 1044 is also connected to bus 1306 via an interface, such as a video adapter 1046. Display screen 1044 may be external to, or incorporated in computing device 1000. Display screen 1044 may display information, as well as being a user interface for receiving user commands and/or other information (e.g., by touch, finger gestures, virtual keyboard, etc.). In addition to display screen 1044, computing device 1000 may include other peripheral output devices (not shown) such as speakers and printers.

Computing device 1000 is connected to a network 1048 (e.g., the Internet) through an adaptor or network interface 1050, a modem 1052, or other means for establishing communications over the network. Modem 1052, which may be internal or external, may be connected to bus 1006 via serial port interface 1042, as shown in FIG. 10, or may be connected to bus 1006 using another interface type, including a parallel interface.

As used herein, the terms “computer program medium,” “computer-readable medium,” and “computer-readable storage medium” are used to refer to physical hardware media such as the hard disk associated with hard disk drive 1014, removable magnetic disk 1018, removable optical disk 1022, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1032 and other programs 1034) may be stored on the hard disk, magnetic disk, optical disk, ROM, RAM, or other hardware storage medium. Such computer programs may also be received via network interface 1050, serial port interface 1042, or any other interface type. Such computer programs, when executed or loaded by an application, enable computing device 1000 to implement features of embodiments discussed herein. Accordingly, such computer programs represent controllers of the computing device 1300.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A display magnification system is described herein. The display magnification system is implemented in a computing device and configured to enable the magnification of selectable display objects. The display magnification system includes: a magnification event monitor configured to: detect a first interaction event associated with a first selectable display object displayed in a display screen, the display screen having a boundary and a current magnification level, and determine a first display location and a first unmagnified size of the first selectable display object in the display screen; a magnified object size determiner configured to: determine a magnified display size for the first selectable display object based at least on the first unmagnified size; a magnified object location determiner configured to: determine a second display location for the first selectable display object based at least on the first display location; and a display interface configured to: display the first selectable display object at the magnified display size and at the second display location on the display screen, the display screen otherwise displayed entirely at the current magnification level.

In one embodiment of the foregoing system, the system further includes: a magnifier mode initiator configured to, prior to said detecting, initiate a focus magnification mode for display of selected selectable display objects in the display screen.

In another embodiment of the foregoing system, to determine the magnified display size for the first selectable display object based at least on the first unmagnified size, the magnified object size determiner is configured to: determine the magnified display size for the first selectable display object based on the first unmagnified size and a magnification level associated with the focus magnification mode.

In another embodiment of the foregoing system, to determine a second display location for the first selectable display object based at least on the first display location, the magnified object location determiner is configured to: determine that the first selectable display object, at the magnified display size and at a default magnified display location, extends outside of the boundary; and generate the second display location as an adjustment of the default magnified display location to enable the first selectable display object, at the magnified display size, to fit within the boundary.

In another embodiment of the foregoing system, the default magnified display location is determined relative to the first display location for the first selectable display object.

In another embodiment of the foregoing system, the magnification event monitor is further configured to: detect a second interaction event associated with a second selectable display object displayed in the display screen, and determine a third display location and a second unmagnified size of the second selectable display object in the display screen; the magnified object size determiner is further configured to: determine a second magnified display size for the second selectable display object based at least on the second unmagnified size; the magnified object location determiner is further configured to: determine a fourth display location for the second selectable display object based at least on the third display location; and the display interface is further configured to: display the second selectable display object at the second magnified display size and at the fourth display location on the display screen, the first selectable display object and the display screen otherwise displayed entirely at the current magnification level.

In another embodiment of the foregoing system, the magnification event monitor is further configured to: enable user interaction events to step through selectable display objects for individual magnified display in the display screen.

A method in a computing device is described herein. The method includes detecting a first interaction event associated with a first selectable display object displayed in a display screen, the display screen having a boundary and a current magnification level; determining a first display location and a first unmagnified size of the first selectable display object in the display screen; determining a magnified display size for the first selectable display object based at least on the first unmagnified size; determining a second display location for the first selectable display object based at least on the first display location; and displaying the first selectable display object at the magnified display size and at the second display location on the display screen, the display screen otherwise displayed entirely at the current magnification level.

In one embodiment of the foregoing method, the method further comprises: initiating a focus magnification mode for display of selected selectable display objects in the display screen prior to said detecting.

In another embodiment of the foregoing method, said determining a magnified display size for the first selectable display object based at least on the first unmagnified size comprises: determining the magnified display size for the first selectable display object based on the first unmagnified size and a magnification level associated with the focus magnification mode.

In another embodiment of foregoing method, the said determining a second display location for the first selectable display object based at least on the first display location comprises: determining that the first selectable display object, at the magnified display size and at a default magnified display location, extends outside of the boundary; and generating the second display location as an adjustment of the default magnified display location to enable the first selectable display object, at the magnified display size, to fit within the boundary.

In another embodiment of the foregoing method, the default magnified display location is determined relative to the first display location for the first selectable display object.

In another embodiment of the foregoing method, the method further comprises: detecting a second interaction event associated with a second selectable display object displayed in the display screen; determining a third display location and a second unmagnified size of the second selectable display object in the display screen; determining a second magnified display size for the second selectable display object based at least on the second unmagnified size; determining a fourth display location for the second selectable display object based at least on the third display location; and displaying the second selectable display object at the second magnified display size and at the fourth display location on the display screen, the first selectable display object and the display screen otherwise displayed entirely at the current magnification level.

In another embodiment of the foregoing method, the method further comprises enabling user interaction events to step through selectable display objects for individual magnified display in the display screen.

A computer-readable medium having computer program logic recorded thereon that when executed by at least one processor causes the at least one processor to perform a method, the method comprises: detecting a first interaction event associated with a first selectable display object displayed in a display screen, the display screen having a boundary and a current magnification level; determining a first display location and a first unmagnified size of the first selectable display object in the display screen; determining a magnified display size for the first selectable display object based at least on the first unmagnified size; determining a second display location for the first selectable display object based at least on the first display location; and displaying the first selectable display object at the magnified display size and at the second display location on the display screen, the display screen otherwise displayed entirely at the current magnification level.

In one embodiment of the foregoing computer-readable medium, the method further comprises: initiating a focus magnification mode for display of selected selectable display objects in the display screen prior to said detecting.

In another embodiment of the foregoing computer-readable medium, said determining a magnified display size for the first selectable display object based at least on the first unmagnified size comprises: determining the magnified display size for the first selectable display object based on the first unmagnified size and a magnification level associated with the focus magnification mode.

In another embodiment of the foregoing computer-readable medium, said determining a second display location for the first selectable display object based at least on the first display location comprises: determining that the first selectable display object, at the magnified display size and at a default magnified display location, extends outside of the boundary; and generating the second display location as an adjustment of the default magnified display location to enable the first selectable display object, at the magnified display size, to fit within the boundary.

In another embodiment of the foregoing computer-readable medium, the default magnified display location is determined relative to the first display location for the first selectable display object.

In another embodiment of the foregoing computer-readable medium, the method further comprises: detecting a second interaction event associated with a second selectable display object displayed in the display screen; determining a third display location and a second unmagnified size of the second selectable display object in the display screen; determining a second magnified display size for the second selectable display object based at least on the second unmagnified size; determining a fourth display location for the second selectable display object based at least on the third display location; and displaying the second selectable display object at the second magnified display size and at the fourth display location on the display screen, the first selectable display object and the display screen otherwise displayed entirely at the current magnification level.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A display magnification system in a computing device, comprising:
a magnification event monitor configured to:
detect a first interaction event associated with a first selectable display object displayed in a display screen, the display screen having a boundary and a current magnification level, and
determine a first display location and a first unmagnified size of the first selectable display object in the display screen;
a magnified object size determiner configured to:
determine a magnified display size for the first selectable display object based at least on the first unmagnified size;
a magnified object location determiner configured to:
determine a second display location for the first selectable display object based at least on the first display location; and
a display interface configured to:
display the first selectable display object at the magnified display size and at the second display location on the display screen, the display screen otherwise displayed entirely at the current magnification level.

2. The system of claim 1, wherein the system further comprises:
a magnifier mode initiator configured to, prior to said detecting, initiate a focus magnification mode for display of selected selectable display objects in the display screen.

3. The system of claim 2, wherein, to determine the magnified display size for the first selectable display object based at least on the first unmagnified size, the magnified object size determiner is configured to:
determine the magnified display size for the first selectable display object based on the first unmagnified size and a magnification level associated with the focus magnification mode.

4. The system of claim 1, wherein, to determine a second display location for the first selectable display object based at least on the first display location, the magnified object location determiner is configured to:
determine that the first selectable display object, at the magnified display size and at a default magnified display location, extends outside of the boundary; and
generate the second display location as an adjustment of the default magnified display location to enable the first selectable display object, at the magnified display size, to fit within the boundary.

5. The system of claim 4, wherein the default magnified display location is determined relative to the first display location for the first selectable display object.

6. The system of claim 1, wherein:
the magnification event monitor is further configured to:
detect a second interaction event associated with a second selectable display object displayed in the display screen, and
determine a third display location and a second unmagnified size of the second selectable display object in the display screen;
the magnified object size determiner is further configured to:
determine a second magnified display size for the second selectable display object based at least on the second unmagnified size;
the magnified object location determiner is further configured to:
determine a fourth display location for the second selectable display object based at least on the third display location; and
the display interface is further configured to:
display the second selectable display object at the second magnified display size and at the fourth display location on the display screen, the first selectable display object and the display screen otherwise displayed entirely at the current magnification level.

7. The system of claim 1, wherein the magnification event monitor is further configured to:
enable user interaction events to step through selectable display objects for individual magnified display in the display screen.

8. A method in a computing device, comprising:
detecting a first interaction event associated with a first selectable display object displayed in a display screen, the display screen having a boundary and a current magnification level;
determining a first display location and a first unmagnified size of the first selectable display object in the display screen;
determining a magnified display size for the first selectable display object based at least on the first unmagnified size;
determining a second display location for the first selectable display object based at least on the first display location; and
displaying the first selectable display object at the magnified display size and at the second display location on the display screen, the display screen otherwise displayed entirely at the current magnification level.

9. The method of claim 8, further comprising:
initiating a focus magnification mode for display of selected selectable display objects in the display screen prior to said detecting.

10. The method of claim 9, wherein said determining a magnified display size for the first selectable display object based at least on the first unmagnified size comprises:
determining the magnified display size for the first selectable display object based on the first unmagnified size and a magnification level associated with the focus magnification mode.

11. The method of claim 8, wherein said determining a second display location for the first selectable display object based at least on the first display location comprises:
determining that the first selectable display object, at the magnified display size and at a default magnified display location, extends outside of the boundary; and
generating the second display location as an adjustment of the default magnified display location to enable the first selectable display object, at the magnified display size, to fit within the boundary.

12. The method of claim 11, wherein the default magnified display location is determined relative to the first display location for the first selectable display object.

13. The method of claim 8, further comprising:
detecting a second interaction event associated with a second selectable display object displayed in the display screen;
determining a third display location and a second unmagnified size of the second selectable display object in the display screen;
determining a second magnified display size for the second selectable display object based at least on the second unmagnified size;
determining a fourth display location for the second selectable display object based at least on the third display location; and
displaying the second selectable display object at the second magnified display size and at the fourth display location on the display screen, the first selectable display object and the display screen otherwise displayed entirely at the current magnification level.

14. The method of claim 8, further comprising:
enabling user interaction events to step through selectable display objects for individual magnified display in the display screen.

15. A computer-readable medium having computer program logic recorded thereon that when executed by at least one processor causes the at least one processor to perform a method, the method comprising:
detecting a first interaction event associated with a first selectable display object displayed in a display screen, the display screen having a boundary and a current magnification level;
determining a first display location and a first unmagnified size of the first selectable display object in the display screen;
determining a magnified display size for the first selectable display object based at least on the first unmagnified size;
determining a second display location for the first selectable display object based at least on the first display location; and
displaying the first selectable display object at the magnified display size and at the second display location on the display screen, the display screen otherwise displayed entirely at the current magnification level.

16. The computer-readable medium of claim 15, wherein the method further comprises:
initiating a focus magnification mode for display of selected selectable display objects in the display screen prior to said detecting.

17. The computer-readable medium of claim 16, wherein said determining a magnified display size for the first selectable display object based at least on the first unmagnified size comprises:
determining the magnified display size for the first selectable display object based on the first unmagnified size and a magnification level associated with the focus magnification mode.

18. The computer-readable medium of claim 15, wherein said determining a second display location for the first selectable display object based at least on the first display location comprises:
determining that the first selectable display object, at the magnified display size and at a default magnified display location, extends outside of the boundary; and
generating the second display location as an adjustment of the default magnified display location to enable the first selectable display object, at the magnified display size, to fit within the boundary.

19. The computer-readable medium of claim 18, wherein the default magnified display location is determined relative to the first display location for the first selectable display object.

20. The computer-readable medium of claim 15, wherein the method further comprises:
detecting a second interaction event associated with a second selectable display object displayed in the display screen;
determining a third display location and a second unmagnified size of the second selectable display object in the display screen;
determining a second magnified display size for the second selectable display object based at least on the second unmagnified size;
determining a fourth display location for the second U selectable display object based at least on the third display location; and
displaying the second selectable display object at the second magnified display size and at the fourth display location on the display screen, the first selectable display object and the display screen otherwise displayed entirely at the current magnification level.
